(19) United States
(12) Patent Application Publication
(10) Pub. No.: US 2012/0279308 A1
(43) Pub. Date: Nov. 8, 2012

(54) ELASTIC WAVE RAIL DEFECT DETECTION SYSTEM

(75) Inventors: Fei Yan, State College, PA (US); Steven E. Owens, Bellefonte, PA (US); Michael J. Avioli, Norristown, PA (US); Joseph L. Rose, State College, PA (US)

(73) Assignee: FBS, INC., State College, PA (US)

(21) Appl. No.: 13/463,977

(22) Filed: May 4, 2012

Related U.S. Application Data
(60) Provisional application No. 61/482,464, filed on May 4, 2011.

(51) Int. Cl. G01N 29/04

(52) U.S. Cl. 73/636

(57) ABSTRACT

A rail defect detection system includes a controller in signal communication with at least one transducer. The at least one transducer is configured to receive a predetermined number of guided elastic wave modes at specific frequencies and with specific wave structures from a rail and generate a signal in response. The controller includes a processor configured to identify a defect disposed along the rail in response to the signal received from the at least one transducer.

### CROSS-REFERENCE TO RELATED APPLICATIONS

This application claims priority to U.S. Provisional Patent Application No. 61/482,464, filed May 4, 2011, the entirety of which is herein incorporated by reference.

### FIELD OF DISCLOSURE

The disclosed system and method relate to guided elastic wave methods for defect detection in railroad tracks. More particularly, the disclosed system and method relate to rail break detection systems and methods of detecting a defect or break in a rail.

### BACKGROUND

Rail breaks have been one of the primary causes leading to train accidents. Three common approaches are available for rail break detection: track circuits, inspection vehicles riding on the rail tracks, and elastic wave based systems installed on rail tracks. Electrical track circuits can provide continuous real-time monitoring of rail track integrity; however, electrical track circuits usually require installations of special insulated joints. Electrical track circuits are also prone to interferences from other rail electrical signals and environmental conditions such as a wet rail surface. Inspection vehicles equipped with ultrasonic wheel probes, EMATs, or magnetic flux sensors provide rail inspection results when they ride over the rail tracks. They can thus only be used during scheduled maintenance with the train operation discontinued or interrupted.

### SUMMARY

In some embodiments, a rail defect detection system includes a controller in signal communication with at least one transducer. The at least one transducer is configured to receive a predetermined number of guided elastic wave modes at specific frequencies and with specific wave structures from a rail and generate a signal in response. The controller includes a processor configured to identify a defect disposed along the rail in response to the signal received from the at least one transducer.

In some embodiments, a method includes receiving a predetermined number of guided elastic wave modes at specific frequencies and with specific wave structures from a rail at one or more transducers, converting an analog signal representative of the predetermined number of guided elastic wave modes at specific frequencies and with specific wave structures to a digital signal, and processing the digital signal to identify if the rail includes a defect.

### BRIEF DESCRIPTION OF THE DRAWINGS

FIGS. 1A and 1B illustrate one example of the components of a rail head detection system in accordance with some embodiments.

FIG. 2 is a perspective view of one example of a rail break detection system in accordance with some embodiments.

FIG. 3 illustrates one example of a phase velocity dispersion curve of a rail.

FIG. 4 is a perspective view of one example of rail head transducers.

FIGS. 5A and 5B are perspective views illustrating one example of rail head transducers coupled to rail cross-sections available at a mechanical joint made by fishplates.

FIGS. 6A and 6B illustrate examples of rail head transducer installations.

FIG. 7 illustrates one example of longitudinal rail head waves generated by rail head transducers for rail break detection in rails.

FIG. 8 illustrates leaking waves and non-leaking shear horizontal waves in rails.

FIGS. 9A-9E provide perspective views of rail web-installed transducer elements and an example of a comb-type setup.

FIG. 10 illustrates a transverse crack under shelling.

FIG. 11 illustrates two elastic wave energy distributions in rails.

FIG. 12 are perspective views of one example of an air-coupled transducer for rail defect detection.

FIG. 13 illustrates examples of using multiple air-coupled transducers to excite and/or receive elastic waves in rail.

FIG. 14 illustrates one example of a self-cleaning air-coupled transducer.

FIGS. 15A and 15B illustrate one example of an air-coupled transducer mounted under the head of a train for rail defect detection.

FIG. 16A is a flow diagram of one example of a method for separating backward propagating waves from forward propagating waves.

FIG. 16B illustrates one example of a two dimensional data matrix in accordance with the method illustrated in FIG. 16A.

FIG. 17 illustrates an example of air-coupled transducers mounted to an approximate center of a train or other vehicle for rail defect detection.

FIG. 18 illustrates a perspective view of an example of a mechanical striker.

FIG. 19 illustrates one example of a comb-type setup of a plurality of mechanical strikers.

FIG. 20 illustrates one example of a controlled elastic guided wave tone burst in accordance with some embodiments.

FIG. 21 illustrates a sinusoidal signal produced by methods in accordance with some embodiments.

FIG. 22 illustrates examples of strike sequences.

FIG. 23 illustrates the mechanism of elastic wave energy excitation by a moving train.

FIG. 24 illustrates one example of using spaced transducers to optimally receive train energy.

### DETAILED DESCRIPTION

This description of the exemplary embodiments is intended to be read in connection with the accompanying drawings, which are to be considered part of the entire written description.

In some embodiments, one or more of the disclosed transducers for guided elastic waves in rails are combined with one or more of the disclosed methods for detecting and locating rail defects, e.g., a break in the rail, using guided elastic waves. In some embodiments, the transducers include at least one of rail head transducers, rail web-installed comb type transducers comprising a plurality of spaced transducer elements, air-coupled transducers, and/or mechanical strikers.

The methods for detecting and locating rail defects include a controlled ultrasonic guided wave tone-burst method, a method based on long sinusoidal input signals, a train energy monitoring method, and a method utilizing coded striker impact sequences. Different types of transducers may be combined with different methods in some specific configurations for rail defect detection.

In some embodiments, the rail head transducer is optimized to be coupled horizontally to a head section of an accessible cross-section of a rail. Accessible cross-sections of rails are located in mechanical joints made by using fishplates. The transducer size, type, operating frequencies, coupling location within the rail head cross-section, and the fixture and methods to couple the transducer to the rail are optimized according to the wave mechanics of elastic waves in rails. Selective excitation and reception of special elastic wave modes and frequencies are achieved based on an optimization such that interference to rail defect detection caused by different rail conditions can be suppressed.

In some embodiments, a plurality of spaced transducer elements are coupled to a rail web location and are configured to transmit and/or receive elastic wave energies. The transducer elements are inclined to have an angle with respect to the axial direction of the rail. The inclined angle and the transducer element spacing are specified such that selective excitation and reception of special elastic wave modes and frequencies are achieved. Interference to rail defect detection due to different rail conditions can therefore be suppressed.

In some embodiments, an air-coupled transducer is placed at a location between zero inches and ten inches to a rail. The face of the transducer is placed to face the rail at an angle. The angle and the location of the air-coupled transducer are optimized to selectively excite and/or receive special elastic wave modes and frequencies such that interference to rail defect detection caused by different rail conditions can be suppressed.

In some embodiments, a plurality of spaced air-coupled transducers are used together to enhance the elastic wave mode and frequency selectivity and penetration power.

In some embodiments, one or more mechanical strikers are placed adjacent to a rail. The locations where the striker(s) hit on the rail and the spacing of different strikers are specified to ensure appropriate excitation of preferred elastic wave modes and frequencies that are not sensitive to certain complex rail conditions such as bolt holes in the rail web, vibration absorption materials under the rail base, and thermite welds.

In some embodiments, one or more of the transducers are combined with a controlled guided wave tone-burst method to detect and locate rail defects. At least two transducers are used under pitch-catch (through-transmission) and pulse-echo modes for rail defect detection and localization, respectively. Under a pitch-catch mode, tone-burst elastic wave energy is sent from one transducer to the other in the format of the special guided elastic wave modes and frequencies determined by the transducer setup. Disturbance of guided wave reception at the receiver transducer is used to detect a rail defect. In the pulse-echo mode, one of the two transducers sends guided wave energy into the rail using a tone-bust driving signal. At the end of the driving signal, the transducer turns to a receiving mode to receive any reflections from possible rail defects. If received reflections identify a defect, such as a break in the rail, the locations of the rail defect(s) are determined based on guided wave velocity and time-of-flights (TOFs) of the reflections.

In some embodiments, one or more of the transducers are combined with a long sinusoidal signal based method to detect rail defects. At least one transducer is implemented as a transmitter and at least one transducer is implemented as a receiver. A long electrical sinusoidal signal with 1000 or more cycles is applied to the transmitter transducer to generate elastic wave energy in the rail. The frequency of the sinusoidal signal is selected to produce optimal energy transmission within the rail. Absence or degradation of the received sinusoidal wave is used to detect a rail defect.

In some embodiments, one or more of the transducers are combined with a train energy method to detect rail defects. Moving trains introduce a large amount of energy into rails. Some of the energy travels for a very long distance in a form of elastic wave energy. At least one transducer is configured to optimally receive the elastic wave energy generated by a moving train. The combination of the train location information and the knowledge on the velocity of the wave energies traveling in the rail, absence or degradation of the received train energy within a certain time range provides an indication of a rail defect.

In some embodiments, the mechanical strikers are applied with coded striker impact sequences for rail defect detection. One or more of the transducers are used as receivers to receive the elastic wave energy generated by the striker impacts. The impact sequences are coded with given time delays between sequential impacts. The coded sequence can be correctly recovered via the received signal if there is no rail defect. Distortion of received sequences indicates a possible rail defect between the strikers and the receiving transducers.

In embodiments, the air-coupled transducers are mounted to a train to receive possible train energy reflections from rail defects as the train moves on the rail. One or more transducers may be used together to receive different elastic wave modes and frequencies. As the train moving on the rail, various elastic wave energies are generated by the train and travel at the same direction as the train but with higher velocities. Elastic wave reflections are generated when there is a rail defect in front of the train. The reflections are received by the air-coupled transducers as the indications of the rail defect.

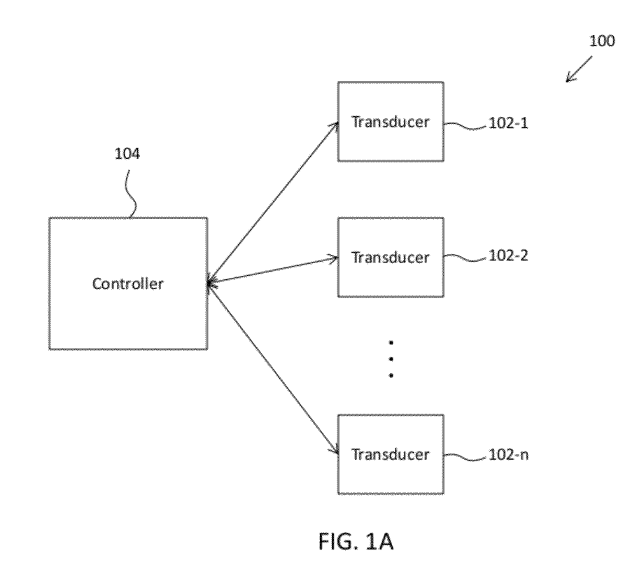

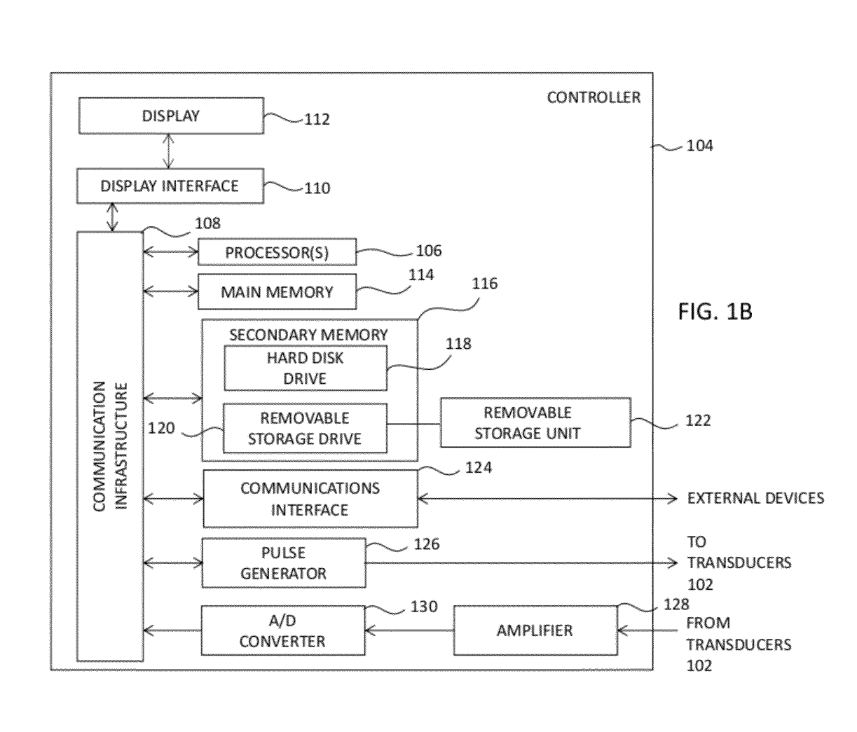

The disclosed methods can be used to implement a rail defect detection system having elastic wave transducers and that provide nearly continuous monitoring of rail with or without complex rail conditions. FIGS. 1A and 1B illustrate one example of a rail defect detection system 100. As shown in FIG. 1A, rail defect detection system 100 includes a number, n, of transducers 102-1, 102-2, . . . , 102-n (collectively “transducers 102”) communicatively coupled to a controller 104. Transducers 102 can be piezoelectric stack transducers, shear piezoelectric transducers, electrical magnetic acoustic transducers (“EMATs”), or other suitable transistor as will be understood by one of ordinary skill in the art. Transducers 102 can be configured as a transmitter or a receiver in a through-transmission setup. Each of the transducers 102 can also be used as a dual mode transducer under a pulse-echo test mode.

As shown in FIG. 1B, controller 104 includes one or more processors, such as processor(s) 106. Processor(s) 106 may be any central processing unit (“CPU”), microprocessor, micro-controller, or computational device or circuit for executing instructions and be connected to a communication infrastructure 108 (e.g., a communications bus, cross-over bar, or network). Various software embodiments are described in terms of this exemplary controller 104. After reading this description, it will be apparent to one of ordinary skill in the art how to implement the method using other computer systems or architectures.

In some embodiments, controller 104 includes a display interface 110 that forwards graphics, text, and other data from the communication infrastructure 114 (or from a frame buffer not shown) for display on a monitor or display unit 112 that is integrated with or separate from controller 104.

Controller 104 also includes a main memory 114, such as a random access memory (“RAM”), and a secondary memory 116. In some embodiments, secondary memory 116 includes a persistent memory such as, for example, a hard disk drive 118 and/or removable storage drive 120, representing an optical disk drive such as, for example, a DVD drive, a Blu-ray disc drive, or the like. In some embodiments, removable storage drive may be an interface for reading data from and writing data to a removable storage unit 128. Removable storage drive 120 reads from and/or writes to a removable storage unit 122 in a manner that is understood by one of ordinary skill in the art. Removable storage unit 122 represents an optical disc, a removable memory chip (such as an erasable programmable read only memory (“EPROM”), Flash memory, or the like), or a programmable read only memory (“PROM”)) and associated socket, which may be read by and written to by removable storage drive 120. As will be understood by one of ordinary skill in the art, the removable storage unit 122 may include a non-transient machine readable storage medium having stored therein computer software and/or data.

Controller 104 may also include one or more communication interface(s) 124, which allows software and data to be transferred between controller 104 and external devices such as, for example, transducers 102 and optionally to a mainframe, a server, or other device. Examples of the one or more communication interface(s) 124 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. Software and data transferred via communications interface 124 are in the form of signals, which may be electronic, electromagnetic, optical, or other signals capable of being received by communications interface 124. These signals are provided to communications interface(s) 124 via a communications path or channel. The channel may be implemented using wire or cable, fiber optics, a telephone line, a cellular link, a radio frequency (“RF”) link, or other communication channels.

In this document, the terms “computer program medium” and “non-transient machine readable medium” refer to media such as removable storage units 122 or a hard disk installed in hard disk drive 118. These computer program products provide software to controller 104. Computer programs (also referred to as “computer control logic”) may be stored in main memory 114 and/or secondary memory 116. Computer programs may also be received via communications interface(s) 124. Such computer programs, when executed by a processor(s) 106, enable the controller 104 to perform the features of the method discussed herein.

In an embodiment where the method is implemented using software, the software may be stored in a computer program product and loaded into controller 104 using removable storage drive 120, hard drive 118, or communications interface(s) 124. The software, when executed by a processor(s) 106, causes the processor(s) 106 to perform the functions of the method described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

Controller 104 also includes a pulse generator 126 configured to output a variety of pulses to transducers 102. For example, pulse generator 126 may transmit time-delayed control signals to transducers 102, and/or pulse generator 126 may transmit control signals of varying amplitudes to transducers 102.

An amplifier 128 is configured to amplify signals received from transducers 102. Such signals received by transducers 102 include reflections of waves from structural features and other anomalies, e.g., rail defects, in rails in response to signals transmitted by pulse generator 126. An analog to digital (“A/D”) converter 130 is coupled to an output of amplifier 128 and is configured to convert analog signals received from amplifier 128 to digital signals. The digital signals output from A/D converter 128 may be transmitted along communication infrastructure 108 where they may undergo further signal processing by processor(s) 106 as will be understood by one of ordinary skill in the art. For synthetic focusing, one of ordinary skill in the art will understand that a plurality of channels may be used in which each channel is coupled to a respective A/D converter 130, but each channel does not need to be connected to a respective pulse generator 126 as in active focusing. System 100 may be configured to perform both active and synthetic focusing.

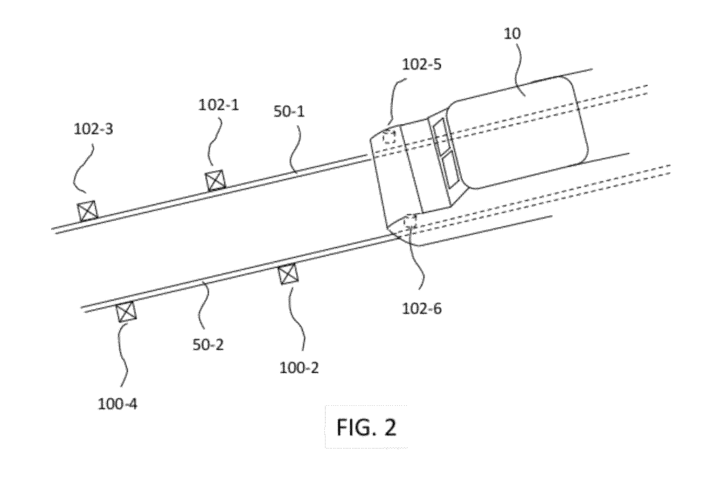

Referring now to FIG. 2, a rail defect detection system 100 includes a plurality of transducers 102-1, 102-2, 102-3, 102-4 installed along the rail tracks 50-1, 50-2 (collectively “rails 50”) and air-coupled transducers 102-5, 102-6 mounted under a train 10. Transducers 102-1, 102-2, 102-3, 102-4 coupled to rails 50 can be rail head transducers, comb type transducers coupled to the rail web, air-coupled transducers, or mechanical strikers. Depending on application requirements, more than one type of transducer 102 can be integrated into a single rail defect detection system. The transducers 102 are designed to selectively excite and/or receive certain elastic wave modes in rails 50 at certain frequencies. As will be understood by one of ordinary skill in the art, the transducers 102 are designed based on elastic wave mechanics including dispersion curve analysis, wave structure (mode shape) analysis, and source influence analysis.

Air-coupled transducers 102-5, 102-6 are optimized to receive possible rail defect reflections of the elastic wave energy generated by the movement of vehicle 10, which may be a train. In some embodiments, air-coupled transducers 102-5, 102-6 disposed on train 10 independently serve as a sole rail defect detection unit or be combined with the transducers 102 disposed along rails 50 in a rail defect detection system. Air-coupled transducers are passively coupled to rails 50, i.e., the active or sensing surface of an air-coupled transducer 102 is coupled to rail through a medium, such as air, such that no direct physical contact exists between the active or sensing surface of transducer 102 and rail 50.

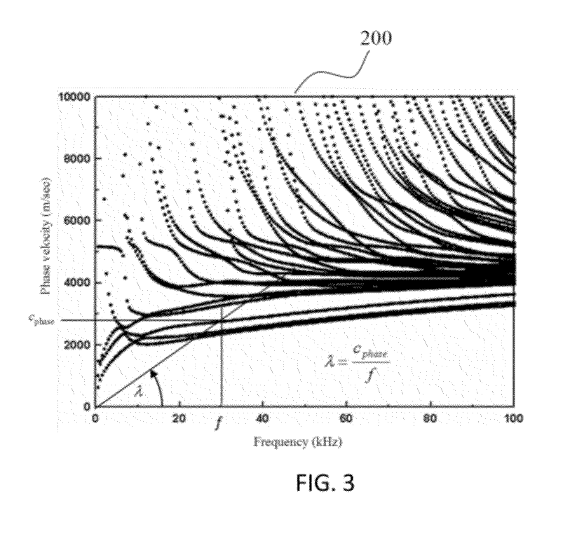

FIG. 3 illustrates one example of a phase velocity dispersion curves 200 for elastic waves in a rail. The dispersion curves 200 describe possible elastic wave phase velocity and frequency combinations that can travel in a rail 50. Note that the points shown in FIG. 2 can be connected across different frequencies to form a number of continuous curves to represent different elastic wave modes. Therefore, theoretically speaking, there are an infinite number of mode and frequency combinations for elastic waves in a rail 50. Each mode and frequency combination represents a unique way of elastic wave energy propagation in a rail 50. The wave energy distribution in a rail cross-section is different from one mode and frequency combination to another, so are the cross-sectional particle displacement profiles (often referred as “displacement wave structures”). The disclosed system 100 makes use of select wave modes and frequency combinations that can travel in a rail 50, e.g. energy confined to the rail head, energy evenly distributed in the rail head 56, web 54, and foot 58, and special wave structures with minimum energy leaking to water on the rail surface list a few possible examples. The desired wave mode and frequency combinations are selectively excited and/or received via special designs of transducers and/or mechanical strikers.

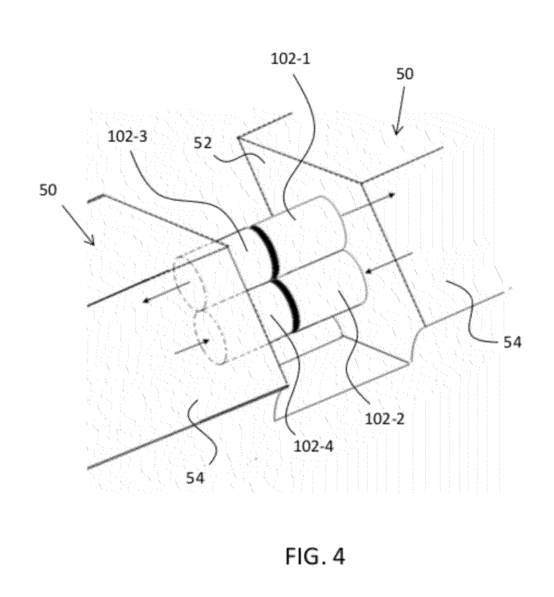

Referring now to FIG. 4, rail head transducers 102 are shown coupled horizontally to accessible cross-sections 52 of rails 50. Put another way, transducers 102 are coupled to rail head 54 of rail 50 such that transducers 102 are disposed along a longitudinal axis defined by the head 54 of rail 50. Accessible rail cross-sections 52 are often found at mechanical joints made using fishplates.

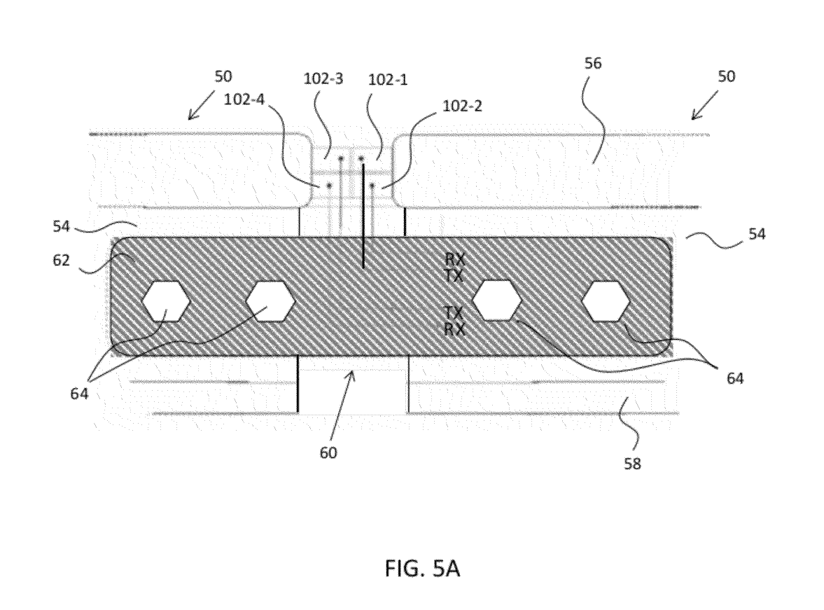

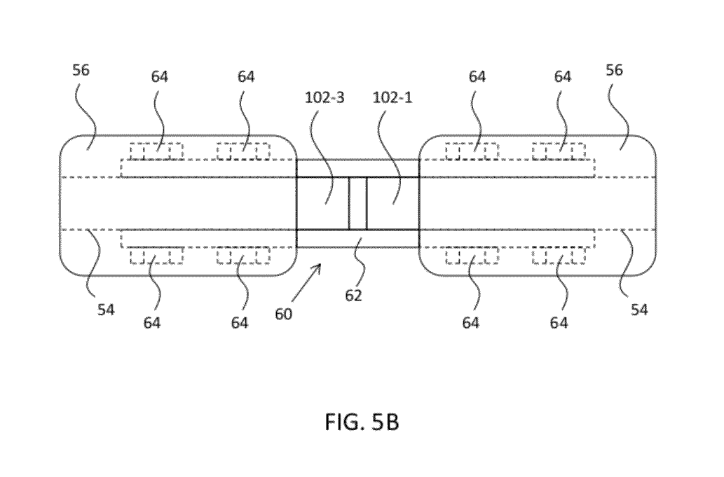

As shown in FIGS. 5A and 5B, a plurality of head transducers 102 are installed within the open accessible area of a mechanical joint 60 made by connecting fishplates 62 and bolts 64 to webs 54 of rails 50. Webs 54 are disposed between the head 56 and feet 58 of rails 50. Transducers 102 are coupled to the rail heads 56. As described above, transducers 102 can be piezoelectric stack transducers, shear piezoelectric transducers, EMATs, or other suitable transistor as will be understood by one of ordinary skill in the art. Transducers 102 can be configured as a transmitter (“TX”) or a receiver (“RX”) in a tone burst through-transmission setup. Each of the transducers 102 can also be used as a dual mode transducer under a pulse-echo test mode.

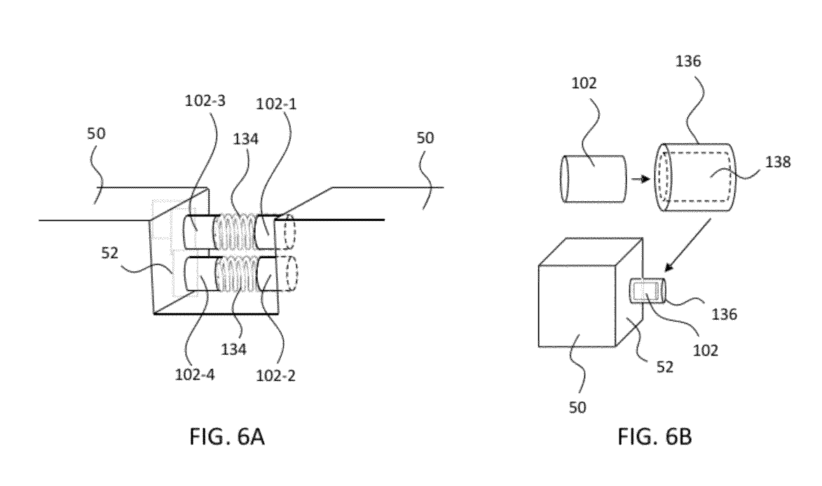

Turning now to FIG. 6A, a plurality of rail head transducers 102 are coupled to accessible rail cross-sections 52 through compression springs 134, which serve as a coupling device for coupling a transducer 102 to rail 50. Compression springs 134 maintain the engagement between transducers 102 and cross-section 52 of rail 50. In some embodiments, such as the embodiment illustrated in FIG. 6B, transducers 102 are disposed within a cavity 138 defined by a magnetic cup 136, which serves as a coupling device for coupling transducer 102 to rail 50. In some embodiments, transducers 102 are coupled to a rail head 56 through mechanical arms installed to the fishplates 62 or fixtures.

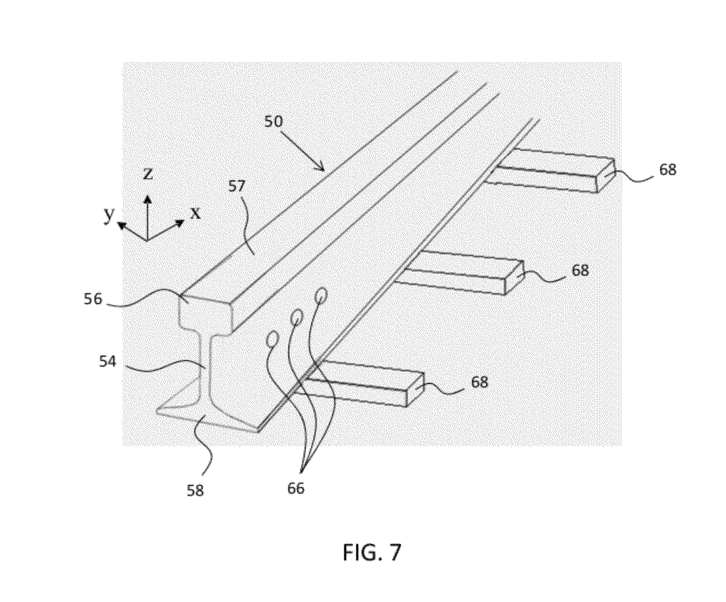

Rail head transducers 102 are configured to generate and/or receive longitudinal waves that travel long distances greater than or equal to ¼ of a mile in a rail 50 with many bolt holes in the web 54 and vibration absorption materials 68 under the foot or base 58. Three directions are defined in a rail head as illustrated in FIG. 7, i.e., longitudinal direction (x-direction), shear horizontal direction (y-direction), and vertical direction (z-direction). Longitudinal elastic waves are waves propagating in the longitudinal direction (x-direction) along with the longitudinal particle displacements caused by the wave motion dominating the overall particle displacement field. Different longitudinal elastic wave modes and frequencies have different energy distributions across a rail cross-section. By optimizing the size, frequency, and position of longitudinal type rail head transducers 102, longitudinal elastic waves with most of their energy constrained in the rail head 56 can be selectively generated and/or received by the rail head transducers 102. Such longitudinal elastic waves can travel distances of greater than or equal to ¼ of a mile even in rails with multiple bolt holes 66 in the rail web 54 and vibration absorption materials 68 under the rail base 58.

Through modeling work and experimentation, rail head waves that can pass through thermite welds with minimum attenuation and minimum wave scattering may be identified and be selectively excited and/or received by the rail head transducers 102. The distances between rail head transducers 102 installed at different accessible rail cross-sections 52 for rail defect detections can therefore be more than ¼ of a mile. The rail defect detection results can also be relatively independent of rail web and base conditions. When elastic wave modes and frequencies with sufficient energy close to the surface of rail heads are selected for rail defect detection, the transducers may also be used to detect train locations as elastic energy reflections can be generated from the wheels on the rail. Commonly assigned U.S. Pat. No. 7,938,008 issued to Owens et al., the entirety of which is herein incorporated by reference, describes such non-destructive defect detection.

The longitudinal rail head transducers 102 may be optimized to generate and/or receive longitudinal waves with energy constrained in the lower part of the rail head 56. With small portions of the longitudinal energy close to the rail head surface 57, wave interactions with trains on rails may be minimized to ensure reliable rail defect detection results when trains are present.

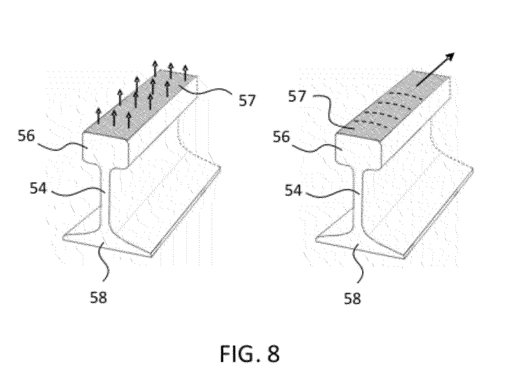

FIG. 8 illustrates two different types of elastic waves in rails with a wet surface. The leaking waves are elastic waves with significant vertical particle displacements on the surface of a rail head such that their energy leak into water while the waves travel along the rail. The attenuation of leaking waves with respect to propagating distances can increase significantly when the rail head surface 57 becomes wet. To enhance the robustness of rail defect detection systems under the wet rail surface conditions, shear horizontal (SH) type waves can be used. SH waves have dominant shear horizontal particle displacement fields. Due to the fact that liquids do not support shear motions very well, SH waves have little to no energy leakage into water on the rail surfaces. Referring again to FIG. 4, rail head transducers 102 can be configured to selectively excite and/or receive SH waves in rails. Piezoelectric shear transducers, EMATs, or other transducers may be used as will be understood by one of ordinary skill in the art.

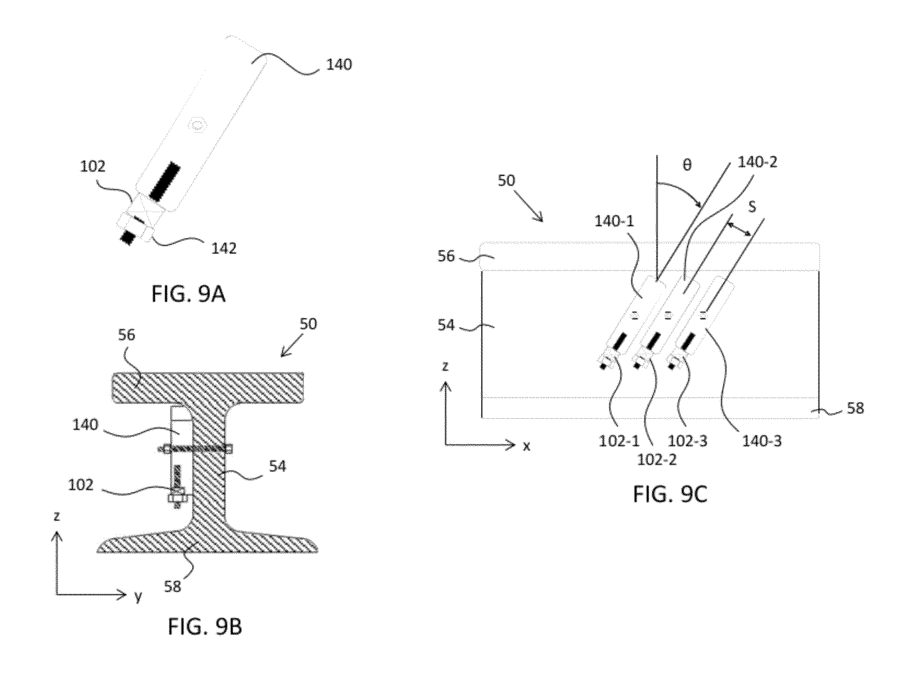

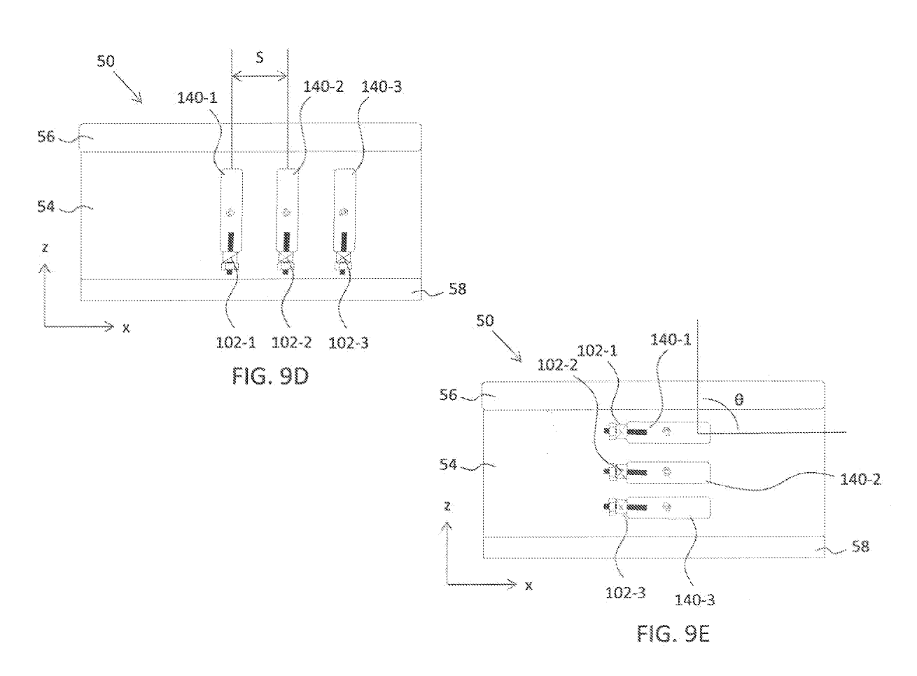

Referring now to FIGS. 9A-9E, one or more transducers 102 are installed on the web 54 of a rail 50 to selectively excite and/or receive predetermined elastic wave mode and frequency combinations. Referring first to FIGS. 9A and 9B, a mounting plate 140 in combination with bolt 142 are used as a coupling device for coupling transducer 102 to the web 54 of a rail 50. Dry couplant may be applied between the transducer 102 and the mounting plate 140.

FIGS. 9C-9E illustrate a comb or arrayed configuration of transducers 102 each being respectively coupled to web 54 by a mounting plate 140. In some embodiments, transducers 102 are coupled to web 54 by a single mounting plate 140 instead of a plurality of mounting plates as illustrated in FIGS. 9C-9E. The angle θ between the mounting plate 140 and the vertical direction (z-direction) of the rail 50 can be adjusted for selective excitation and reception of different elastic wave modes at different frequencies as illustrated in FIGS. 9C-9E. For example, the angle θ in FIG. 9C is shown as approximately 30 degrees, the angle θ in FIG. 9D is θ degrees, and the angle θ in FIG. 9E is 90 degrees, The spacing distance, S, of transducers 102 can be adjusted to enhance the penetration power as well as the selectivity of predetermined elastic wave modes and frequencies.

In general rail defect detection applications, the angle θ is typically between 0 and 90 degrees. One of ordinary skill in the art will understand that the angle θ may be adjusted to optimally excite and/or receive elastic waves with most of their energy constrained in the rail head 56. The spacing distance, S, can be adjusted to match with the wavelength of the elastic waves to enhance the penetration power and the selectivity of the elastic wave modes and frequencies.

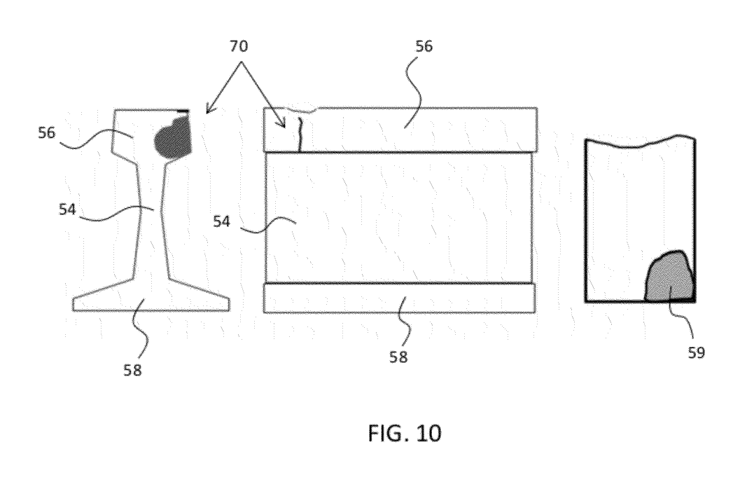

FIG. 10 illustrates one example of a critical type of rail defect: a transverse crack under shelling as described in Lee et al., “A Guided Wave Approach to Defect Detection Under Shelling in Rail,” NDT&E International, Vol. 42, Issue 3, 2009, pp. 174-180, the entirety of which is hereby incorporated by reference. As shown in FIG. 10, a transverse crack 70 is located in rail head 56 underneath a shelling area 59. Such a transverse crack 70 under shelling 59 is difficult to detect by typical rail inspection methods. Using web-installed transducers 102, such as those illustrated and described above with reference to FIGS. 9A-9E, transverse cracks 70 under shelling 59 can be reliably detected when elastic wave modes and frequencies with energy constrained in the lower part of the rail head 56 are selectively excited and/or received for rail defect detection. To use the web-installed transducers 102 for detecting cracks under shelling, the angle θ and comb arrangement of transducers 102 are adjusted to optimally excite and/or receive the elastic waves suitable for detecting cracks 70 under shelling 59.

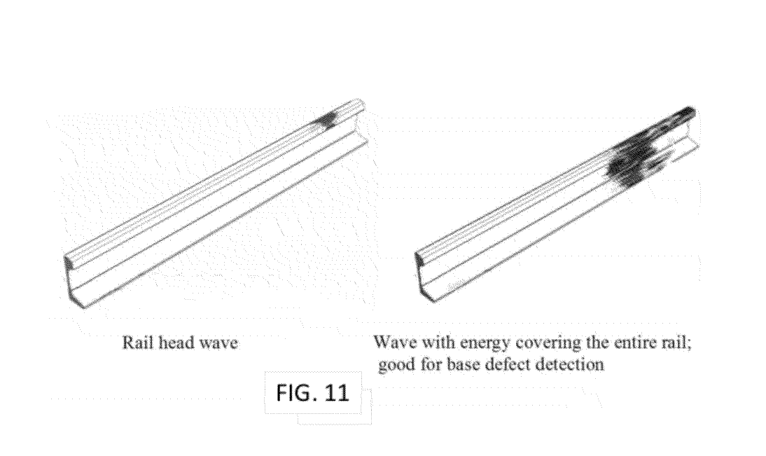

FIG. 11 illustrates examples of elastic waves with energy constrained in the rail head only and elastic waves with energy distributed in the rail head, web, and base. By using the web-installed transducers 102 to selectively excite and/or receive elastic waves with a substantial portion of their energy travels in rail base 58. For example, the waves shown in FIG. 11 can be detected using web-installed transducers 102 to identify rail-base defects.

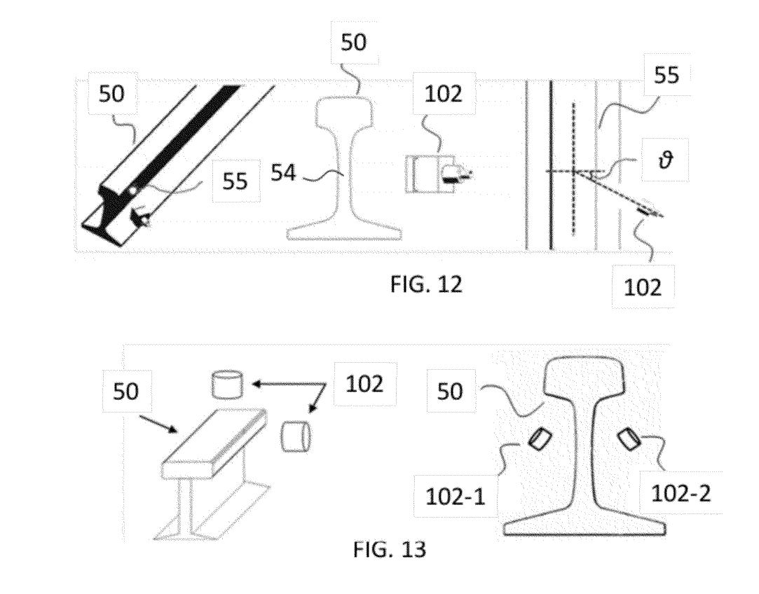

FIG. 12 illustrates examples of using air-coupled transducers 102 for exciting and/or receiving elastic waves in rails 50. Based on Snell's law, the angle θ shown in FIG. 12 can be chosen to selectively excite and/or receive elastic waves with a phase velocity cₐᵢᵣ/sinθ, where cₐᵢᵣ is the sound speed in air. Area 55 on the rail web 54 where the air-coupled transducer 102 excites and/or receives elastic waves from the rail 50 is located and shaped to optimize the wave excitation or reception efficiency.

In FIG. 13, a plurality of air-coupled transducers 102-1, 102-2 are mounted together to excite and/or receive elastic waves in rail 50. The angles at which transducers 102 are positioned are selected to excite and/or receive the same elastic wave modes. The relative locations at which transducers 102 are positioned are determined based on the particle displacement distributions of the elastic waves to be selectively excited and/or received. The elastic wave excitation and/or reception efficiency is dependent on the particle displacements in the area where the air-coupled transducers 102 excite and/or receive the elastic wave energy. Enhanced elastic wave energy excitation and reception can be achieved by positioning air-coupled transducers 102 at particular locations such that they excite and/or receive the elastic wave energy from locations where the particle displacements are in phase.

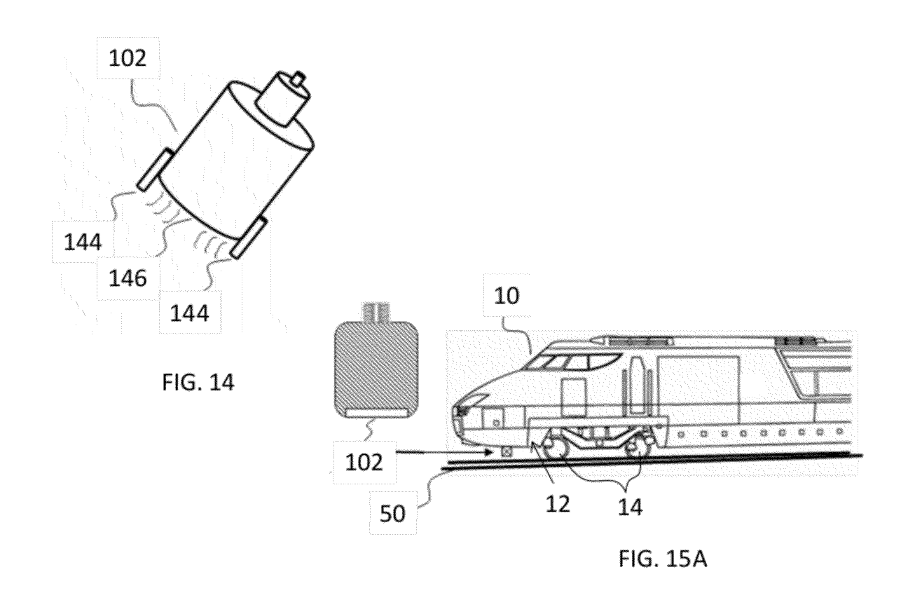

One example of a self-cleaning air-coupled transducer 102 is shown in FIG. 14. One problem of using air-coupled transducers 102 to excite and/or receive elastic waves in rails 50 is that the transducer surfaces become contaminated by dirt after a short period of time. Transducers 102 experience an efficiency drop with contaminated surfaces. The self-cleaning air-coupled transducers 102 for rail track inspection illustrated in FIG. 14 include one or more high pressure air wipers installed close to active or sensing surface 146 of an air-coupled transducer 102. During intervals of using the air-coupled transducers 102 to excite and/or receive elastic waves, air wipers 144 output high pressure air to clean up contaminations on the transducer surface 146. Besides high pressure air wipers, water jets, mechanical wiper blade, or other device can be applied to build self-cleaning air-coupled transducers 102.

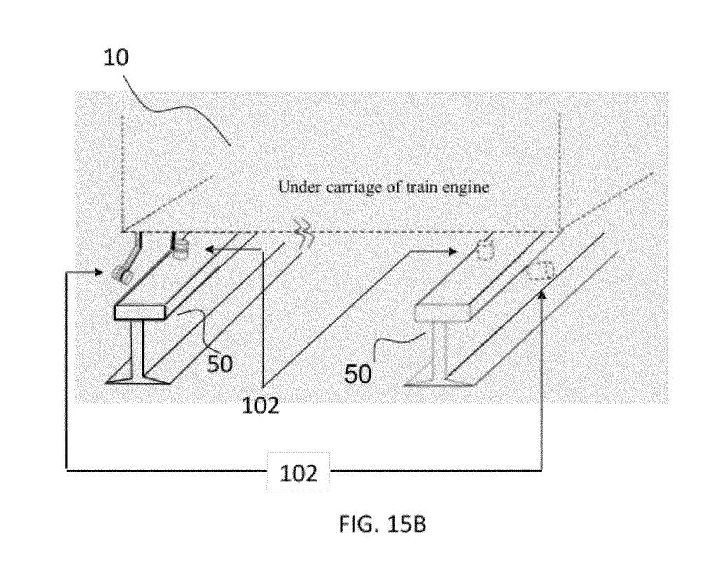

FIGS. 15A and 15B illustrate an example of air-coupled transducers 102 mounted under the head 12 of a train 10 for rail break detection. Air-coupled transducers 102 are configured to selectively excite and/or receive elastic waves in rails 50. Transducers 102 may be used to actively excite elastic waves in rails that travel in the same direction as the train 10 moves. After wave excitation, transducers 102 transition into a receiving mode to receive possible wave reflections from rail defects.

In some embodiments, transducers 102 are configured in a passive receiving only mode. In the passive receiving only mode, the transducers 102 are optimized to receive elastic wave energy propagating towards the train 10. As the train 10 moves along rails 50, elastic waves are generated in the rails 50 through the contacts of the train wheels 14 and the rails 50. Some train generated waves travel in the same direction as the train 10 moves. The velocities of the elastic waves are usually higher than the train speed. As a result, if there are rail defects in front 12 of the train 10, the elastic waves arrive at the defects before the train 10 arrives at the location of the defect(s). The reflections of the elastic waves propagate back towards the moving train 10 and can be received by the air-coupled transducers 102 mounted under the front 12 of the train 10 before the train 10 hits the rail defect. As best seen in FIG. 15B, one or more transducers 102 may be used to enhance the capability of selectively excite and/or receive certain elastic wave modes.

When using air-coupled transducers 102 mounted under the front 12 of a train 10 for rail defect detection, one particular technical challenge is separation of elastic wave reflections from rail defects from the waves generated by the train movements. Compared to the energy of the waves generated by the train movements, the energy of the rail defect reflections is generally much lower.

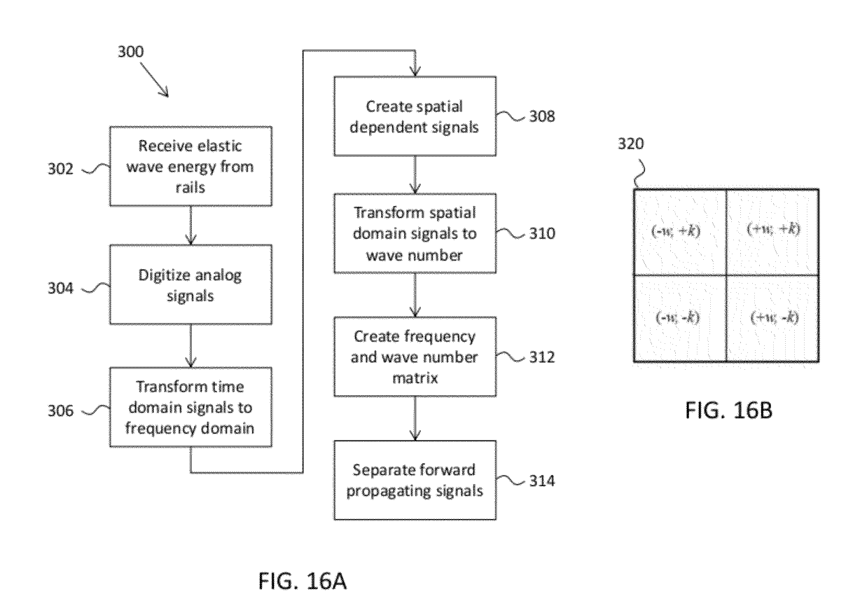

FIG. 16A is a flow diagram of one example of a method 300 for extracting rail defect reflections that travel towards the train 10 from the signals received by transducers 102 mounted under the front 12 of the train 10 or disposed along rails 50. As illustrated in FIG. 16A, the transducers 102 receive elastic wave energy from rails 50 at block 302. Transducers 102 can be configured to selectively receive only certain wave modes or elastic wave energy such that transducers effectively filters all wave energy it receives and passes only the select wave modes or elastic wave energy to controller 104. In some embodiments, transducers 102 are disposed on train 10 and are setup to receive waves traveling towards the train 10, but due to the phase velocity spectrum of the transducers 102, it is still possible for the transducers 102 to get a significant amount of train generated elastic waves that travel in the same direction as the train 10 moves.

At block 304, the analog signal(s) received at controller 104 from transducer(s) 102 is digitized. As will be understood by one of ordinary skill in the art, the analog signal(s) are amplified by amplifier 128 and digitized by an analog-to-digital converter 130. In some embodiments, each of the plurality of transducers 102 disposed along rails 50 provides a respective analog time domain signal to controller 104. Each of the analog time domain signals is amplified by amplifier 128 and digitized by A/D converter 130.

At block 306, the digitized time domain signal(s) are transformed to the frequency domain. In some embodiments, processor(s) 106 perform a Fourier transform to transform the digitized signals from the time domain to the frequency domain.

At block 308, spatial dependent signals are created based on the frequency domain signals. For example, the frequency domain signals generated from the time domain analog signals received from each of the plurality of transducers 102 disposed along rail 50 identifies a plurality of frequencies that form the analog signal. Common frequency data from each of the plurality of transducers 102 are grouped together to form a spatially dependent signal. For example, the 1 kHz frequency signals from each of the plurality of signals disposed along rails 50 is grouped together to form a signal that depicts the 1 kHz signal along the rail 50.

Since the signals are related to equally-spaced transducer mounting locations, a Fourier transform can be performed on the spatial dependent signals at block 310 to provide wave number domain signals.

At block 312, a two dimensional data matrix is mapped into a four quadrant frequency and wave number space. FIG. 16B illustrates one example of such a two dimensional data matrix 320 where ω is the frequency and k is the wave number.

At block 314, the forward propagating wave energy and the energy reflected backward from the rail defect are separated from each other in the two dimensional Fourier transform results based on the separation of the positive wave numbers and the negative wave numbers.

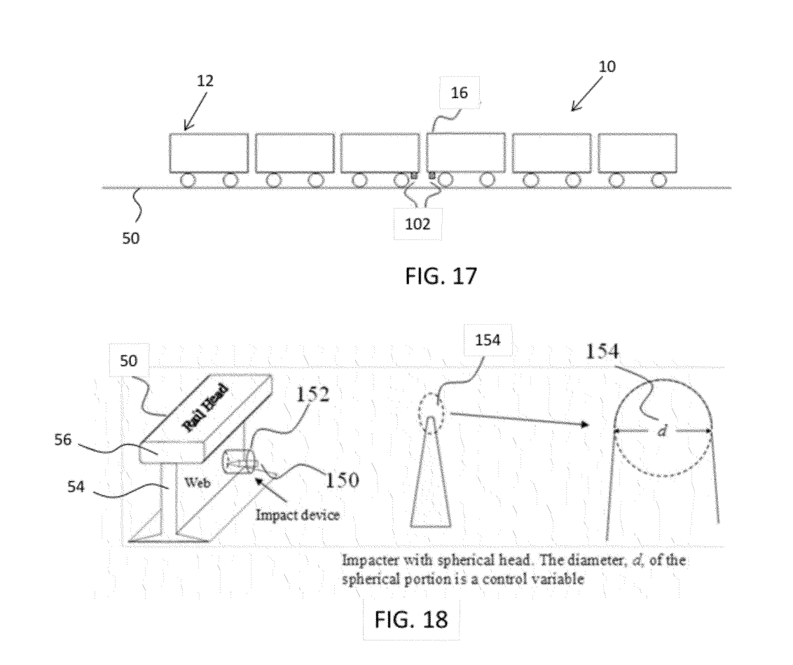

FIG. 17 shows air-coupled transducers 102 mounted on train 10 at a distance from front 12 of train 10. In some embodiments, transducers 102 are coupled to train 10 at an approximate center 16 of train 10. In some embodiments, two sets of air-coupled transducers 102 are implemented. Each set of transistors 102 includes one or more air-coupled transducers disposed at the same angle to the rail 50 for selectively receiving the same elastic wave energy. One set of the transducers 102 is configured to receive waves traveling in the same direction as the train 10 moves while the other set of transducers 102 is configured to receiver waves traveling in the opposite direction.

Signal correlation may be applied to the signals received by the two sets of air-coupled transducers 102 mounted to a location disposed from the front 12 of train 10. In some embodiments, as described above, transducers 102 are positioned at an approximate center 16 of a train 10. However, one of ordinary skill in the art will understand that transducers 102 can be positioned at other positions along the length of train 10. The forward propagating waves that travel in the same direction as the train 10 moves are similar to the backward propagating waves when the two types of waves are received at the transducers 102 disposed along the length of the train 10. The signal correlation between the signals received by the two sets of air-coupled transducers 102 is therefore relatively strong. When a rail defect is located in front of the train 10, however, the backward propagating signals contain the reflection waves from the rail defect resulting in the correlation becoming weaker. Through the evaluation of the signal correlations, one can then determine whether there is a rail defect.

FIG. 18 illustrates one example of mechanical strikers 150 that are designed to excite elastic wave modes in rails 50 at defined frequency ranges. In some embodiments, strikers 150 are directly mounted to the rail web 54 or beside the rail 50 with the striker heads 154 reaching out to the rail 50. The mechanical components of the strikers 150, including the striker heads 154 and the units that drive the strikers 150, are optimized for the elastic wave modes and frequencies to be generated. For instance, the diameter, d, and the hardness of a spherical head 154 may be adjusted such that the contact time and contact area for the striker 150 hitting the rail 50 are optimized to excite selected elastic wave modes at defined frequency ranges. In some embodiments, units include a retractable spring with a release and an electric motor or other striker driving mechanisms as will be understood by one of ordinary skill in the art. In some embodiments, an acoustic shield 152 are be installed together with a striker 150 to shield the acoustic noises that may be generated by the striker 150.

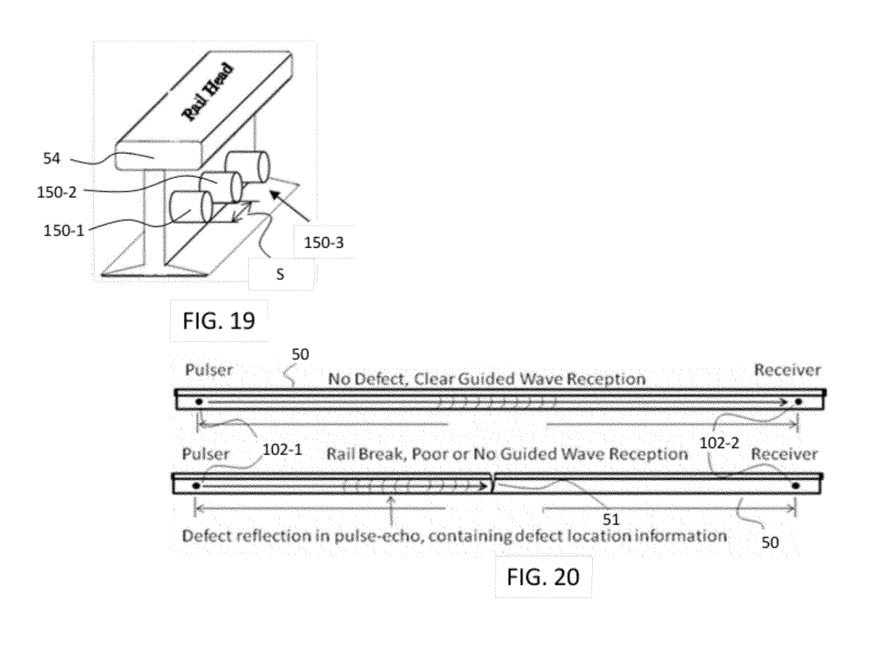

A plurality of spaced mechanical strikers 150-1, 150-2, 150-3 (collectively “strikers 150”) are illustrated in FIG. 19 being applied to enhance the excitation of some specific elastic wave modes. The spacing distance, S, of the strikers 150 is determined by the wavelength of the elastic wave modes to be excited.

Tone-burst elastic waves can be used for rail defect detection and localization. For example and referring to FIG. 20, section of a rail 50 is shown with two rail web-installed transducers 102 being coupled to rail 50. One transducer 102-1 is configured to act as a pulser (i.e., a transmitter) and the other transducer 102-2 is configured as the receiver. By applying electrical tone-burst pulses at predefined frequencies by pulse generator 126 to the transmitter 102-1, one can generate elastic waves in the rail 50.

If there are no rail defects between the transmitter location and the receiver location, the generated elastic waves travel to the receiver transducer 102-2 without reflections at the defects and therefore provide clear elastic wave reception. If a rail defect 51 is located between the transmitter location and the receiver location, elastic waves are reflected back towards the transmitter 102-1 from the rail defect 51 such that there is little-to-no elastic waves received at the receiver transducer location.

In some embodiments, transmitter is used in a pulse-echo mode after an indication of rail defect is determined by a poor or an absent elastic wave reception at the receiver location. Working in the pulse-echo mode, the pulsed transmitter 102-1 first excites elastic waves based on a tone-burst driving signal received from pulse generator 126 and then turns itself into a receiving transducer after the excitation. Transducer 102-2 receives the elastic wave reflections due to the rail defect 51. Based on the velocities of the elastic waves, the distance between the transmitter location and the rail defect is determined by the arrival time of the reflected signal.

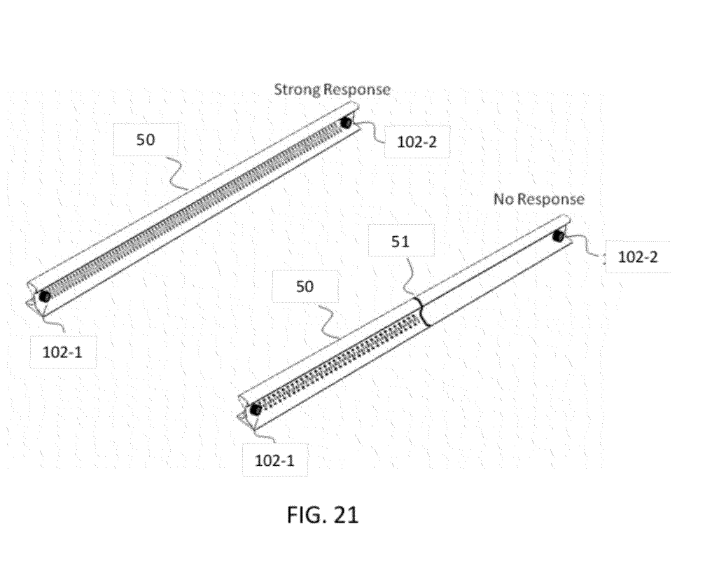

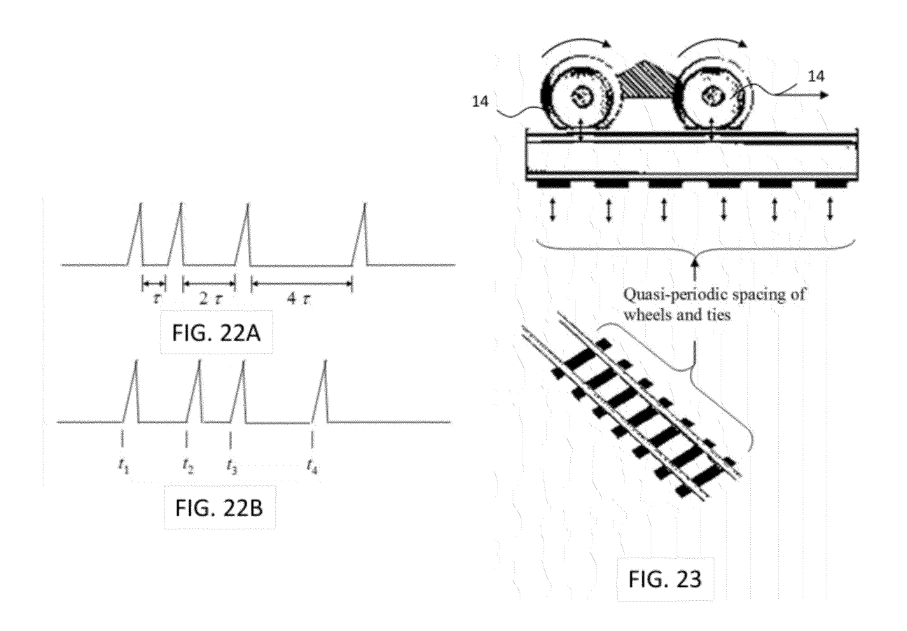

In some embodiments, such as the embodiment illustrated in FIG. 21, sinusoidal signals are used for rail defect detection. As shown in FIG. 22, two transducers 102-1, 102-2 are used with one transducer 102-1 configured as an actuator and the other transducer 102-2 configured as a sensor. As few as 1000 cycles of a sinusoidal signal can be applied to the actuator 102-1 to generate elastic wave energy in the rail 50. Based on the long sinusoidal elastic wave generation, a rail vibration or a transition from elastic wave propagation to vibration may be established. The vibration or wave propagation to vibration transition is measured at the sensor location for rail defect detection. To achieve high energy transmission efficiency, frequency tuning may be performed to identify optimal frequencies that produce maximum energy reception by the sensor 102-2.

When a rail defect 51 is located between the actuator 102-1 and the sensor 102-2, the transmission of the elastic wave energy interacts with the rail defect 51 and results in little-to-no sensor response. A rail break or a rail defect 51 may also change the vibration characteristics of the rail 50 and cause changes in optimal frequencies for maximum energy transmission. Such changes in frequencies may also be used for detection of rail breaks or rail defects.

FIGS. 22A and 22B illustrate two example strike sequences that may be used by mechanical strikers 150 for rail defect detection. When using mechanical strikers 150 to excite elastic waves for rail defect detection, each strike to the rail produces an elastic wave packet traveling along the rail. Since the strikers 150 are optimized to excite select elastic wave modes and frequencies with low attenuation and dispersion, a clear wave packet associated with the impact can be received at a sensor location that is positioned away from the impact location. In some embodiments, the distance between the striker and the receiver is up to two miles.

Each peak in the example striker sequences shown in FIGS. 22A and 22B represents the peak of a received wave packet. The coded strike sequence utilizes time delays between adjacent strikes as the variable for coding. For instance, in FIG. 22A, the code sequence is [τ, 2τ, 4τ] where τ is a time delay. The code sequence in FIG. 22B is [t₁, t₂, t₃, t₄] where tᵢ is an arbitrarily selected time delay. In a rail defect detection application, a mechanical striker 150 provides strikes to a rail based on a coded sequence. A sensor or receiver positioned at a distance along rail 50 is configured to receive the elastic waves that are generated by the striker. Without a rail defect, a coded sequence can be recovered based on the peaks observed in the received signals. If the recovery of the code sequence fails indicating a defect along rail 50.

FIG. 23 illustrates an embodiment in which train energy is used for rail defect detection. Train energy is transferred to a rail via the train wheels 14 such that a moving train 10 can be considered a line source of elastic wave energy. That energy excites quasi-periodic waves via wheel spacing, truck spacing, car spacing, tie spacing, or other spacing as will be understood by one of ordinary skill in the art. These periodic waves will exhibit characteristic modes (elastic wave packet shapes) and frequencies under the conditions of no defect in a rail. If a rail defect exists, a disruption in the mode and frequency (normal rhythm of the train) will be detectable. Thus if receivers 102 are used to “listen” to a train 10, a change will be heard, that change indicating a rail defect.

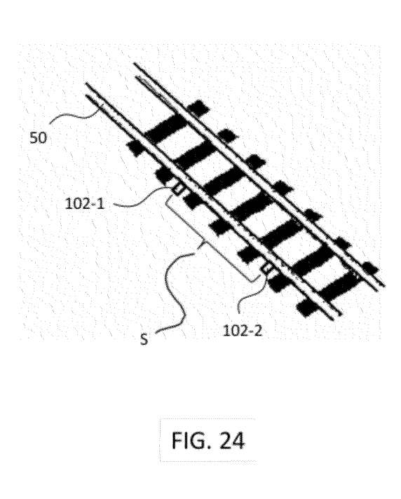

The train induced elastic wave energy may be monitored by transducers 102 spaced at the same spacing or integer multiplications of the critical spacing for the quasi-periodic wave excitation. As illustrated in FIG. 24, a plurality of transducers 102 are spaced at the same spacing, S, or integer multiplications of the tie spacing of the rail 50 for selectively receive the elastic waves induced by a moving train.

A system can be setup to detect defects including partial breaks. By changing frequencies and modes to modes and frequencies sensitive to partial breaks, such partial breaks can be detected.

Custom rail defect detection solutions can be created: With the control that exists over elastic wave propagation, a rail defect detection system can be custom designed to accommodate the specific characteristics of a particular railroad configuration. For example, tie spacings, tie materials, rail materials, densities, and geometric profile and so forth define a railroad in terms of parameters that affect elastic wave propagation in the rail system. Control variables such as frequency, mode, angle of incidence, transducer spacing, and positioning on the rail can be used for custom designs.

Combinations of train transducers sending and sensors on rail receiving: Air transducers 102 or wheel housed transducers 102 can be placed on the undercarriage of the front 12 of the train 10. These transducers 102 can insert elastic waves into the rail 50 that travel faster than the speed that any train can reach. Under no defect conditions, no return energy from the transmitted energy should be received. If a defect 51 is present, the echo from it would travel toward the approaching train 10. A Doppler frequency shift would be evident in the received signal due to the velocity of approach of the train towards the sound source (the defect 51). The receiving sensors past the defect would not receive any (or would receive a reduced amount of) energy.

Combination of rail transducer 102 sending and transducers on train 10 receiving: The roles of the transducers 102 described above would be interchanged. Transmitting transducers 102 would be rail mounted and transmit energy into the rails 50 using a designated frequency and mode. Air coupled 102 or wheel housed transducers 102 would be train mounted and act as receivers. A defect 51 in a rail 50 ahead of an approaching train would be manifested as a signal loss at the train receiver transducer.

The present invention can be embodied in the form of methods and apparatus for practicing those methods. The present invention can also be embodied in the form of program code embodied in tangible media, such as floppy diskettes, CD-ROMs, DVD-ROMs, Blu-ray disks, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A rail defect detection system, comprising:
at least one transducer configured to receive a predetermined number of guided elastic wave modes at specific frequencies and with specific wave structures from a rail and generate a signal in response; and
a controller in signal communication with the at least one transducer, the controller including a processor configured to identify a defect disposed along the rail in response to the signal received from the at least one transducer.

2. The rail defect detection system of claim 1, wherein the at least one transducers includes at least one of a rail head transducer, a rail web-installed comb transducer, an air-coupled transducer, or a mechanical striker.

3. The rail defect detection system of claim 1, wherein the at least one transducer is coupled to a web of the rail by a mounting plate, the at least one transducer being disposed at an angle relative to a longitudinal axis defined by the rail, the angle being selected to excite and/or receive the predetermined number of guided elastic wave modes at specific frequencies and with specific wave structures.

4. The rail defect detection system of claim 1, wherein the at least one transducer includes a plurality of transducers coupled to a web of the rail by a mounting plate, the plurality of transducers being spaced from one another by a distance and are disposed at an angle relative to a longitudinal axis defined by the rail, wherein the distance and the angle are selected for exciting and/or receiving the predetermined number of guided elastic wave modes at specific frequencies and with specific wave structures.

5. The rail defect detection system of claim 1, wherein the at least one transducer is coupled to a coupling device that couples the at least one transducer to a head section of the rail such that the at least one transducer is disposed along a longitudinal axis defined by the rail.

6. The rail defect detection system of claim 5, wherein the coupling device includes a compression spring disposed within a space defined by a first end of a first rail and a second end of a second rail the compression spring configured to exert a force on the at least one transducer to maintain the at least one transducer in contact with one of the first and second ends.

7. The rail defect detection system of claim 1, wherein the at least one transducer is coupled to a vehicle traveling along the rail, the at least one transducer having an active surface coupled to the rail through a medium.

8. The rail defect detection system of claim 7, wherein the at least one transducer includes a self-cleaning device for removing contaminants from a sensing surface of the at least one transducer.

9. The rail defect detection system of claim 1, wherein the at least one transducer includes a first transducer coupled to the rail at a first location and a second transducer disposed at a second location along the rail, the first transducer configured to transmit elastic energy to the second transducer via the rail, and the second transducer configured to receive the elastic energy from the first transducer via the rail.

10. The rail defect detection system of claim 1, wherein the processor is configured to
transform time domain signals received from the at least one transducer to the frequency domain signals using a Fourier transform, the at least one transducer transmitting the time domain signals to the processor when the at least one transducer is positioned at different locations along the rail;
transform the frequency domain signals to spatial domain signals;
transform the spatial domain signals to wave number domain signals; and
separate forward propagating wave data from the backward propagating data based on the wave number domain signals and the frequency domain signals.

11. The rail defect detection system of claim 1, wherein the at least one transducer includes an impact device configured to be actuated in response to signals received from the controller.

12. A method, comprising:
receiving a predetermined number of guided elastic wave modes at specific frequencies and with specific wave structures from a rail at one or more transducers;
converting an analog signal representative of the predetermined number of guided elastic wave modes at specific frequencies and with specific wave structures to a digital signal; and
processing the digital signal to identify if the rail includes a defect.

13. The method of claim 12, wherein the one or more transducers are coupled to one of a head or a web of the rail.

14. The method of claim 12, wherein the predetermined number of guided elastic wave modes at specific frequencies and with specific wave structures are received at the one or more transducers that are configured in one of a tone-burst through-transmission arrangement or in a pulse echo arrangement.

15. The method of claim 12, wherein the one or more transducers are coupled to a vehicle moving along the rail.

16. The method of claim 12, wherein the elastic wave energy received at the one or more transducers are reflected elastic wave energy generated by the vehicle.

17. The method of claim 16, further comprising:
transforming time domain signals received by the one or more transducers to frequency domain signals using a Fourier transform, the one or more transducers generating the time domain signals when positioned at different locations along the rail;
transforming the frequency domain signals to spatial domain signals;
transforming the spatial domain signals to wave number domain signals; and
separating forward propagating wave data from the backward propagating data based on the wave number domain signals and the frequency domain signals

18. The method of claim 12, wherein the predetermined number of guided elastic wave modes at specific frequencies and with specific wave structures received from the rail at the one or more transducers is a reflection from a defect.

19. The method of claim 12, wherein the predetermined number of guided elastic wave modes at specific frequencies and with specific wave structures received from the rail are generated by at least one second transducer that is disposed at a distance along the rail from the one or more transducers.

20. The method of claim 19, wherein the at least one second transducer generates the wherein the predetermined number of guided elastic wave modes at specific frequencies and with specific wave structures by pulsing with a number of cycles that is greater than or equal to 1,000.
